(19) United States
(12) Patent Application Publication
(10) Pub. No.: US 2026/0269917 A1
(43) Pub. Date: Sep. 10, 2026

(54) METHOD AND APPARATUS OF FUNCTIONALITY MONITORING FOR AI/ML-BASED BEAM MANAGEMENT IN MOBILE COMMUNICATIONS

(71) Applicant: MEDIATEK INC., Hsinchu City (TW)

(72) Inventors: Yu-Jen KU, San Jose, CA (US); Gyu Bum KYUNG, San Jose, CA (US)

(21) Appl. No.: 19/165,954

(22) PCT Filed: May 9, 2024
(86) PCT No.: PCT/CN2024/091877

§ 371 Date: Sep. 16, 2025

Related U.S. Application Data
(60) Provisional application No. 63/501,418, filed on May 11, 2023.

(51) Int. Cl. H04B 7/06

(52) U.S. Cl. CPC H04B 7/06952

(57) ABSTRACT

Examples pertaining to functionality monitoring for artificial intelligence (AI)/machine learning (ML)-based beam management in mobile communications are described. A user equipment (UE) detects a need to change an AI/ML beam management functionality. The UE reports a request to change the AI/ML beam management functionality to a network responsive to the detecting and, in response, receives an indication from the network. The UE then applies a decision related to the AI/ML beam management functionality according to the indication.

### CROSS REFERENCE TO RELATED PATENT APPLICATION(S)

The present disclosure is part of a non-provisional application claiming the priority benefit of U.S. Patent Application No. 63/501,418, filed 11 May 2023, the content of which herein being incorporated by reference in its entirety.

### TECHNICAL FIELD

The present disclosure is generally related to mobile communications and, more particularly, to functionality monitoring for artificial intelligence (AI)/machine learning (ML)-based beam management in mobile communications.

### BACKGROUND

Unless otherwise indicated herein, approaches described in this section are not prior art to the claims listed below and are not admitted as prior art by inclusion in this section.

In wireless communications such as mobile communications under the 3^{rd} Generation Partnership Project (3GPP) standards, a user equipment (UE) and a base station (e.g., gNB) need to find a best beam to communicate with each other, yet exhaustive beam sweeping overhead could be significantly increased as the number of available beams increases. Accordingly, beamforming is a technique that can increase downlink (DL) throughput and, thus, is essential for the millimeter wave (mmWave) technology in future wireless systems. Compared with the existing exhaustive beam sweeping procedure, an AI/ML-based solution can provide a faster way to obtain information of the best beam. For instance, an AI/ML-based beam management can reduce the required number and time of layer 1 reference signal received power (L1-RSRP) measurement.

In the context of AI/ML, performance monitoring is a mechanism that takes place after an AI/ML model is trained and deployed at a network and/or UE for inference. It is a mechanism that monitors certain performance metrics to identify that the prediction of AI/ML model is not precise anymore, or to monitor and ensure prediction accuracy. The monitored performance metrics can include, for example, beam prediction accuracy (e.g., the ground-truth best beam that needs to be measured), link-level key performance indicator (KPI) (e.g., the throughput, L1 signal-to-interference-and-noise-ratio (SINR) and L1-RSRP), difference between the input/output data distribution during inference and during training, and difference between the predicted L1-RSRP and the measured L1-RSRP of a specific set of beams. Regarding functionality-based performance monitoring, performance monitoring and corresponding monitoring decision is at functionality level. Moreover, functionality-based performance monitoring identifies whether the performance of an AI/ML functionality is good or bad, and it determines to activation/deactivation/fallback/switching of an AI/ML functionality (to determine which functionality to use, and which model to use depends on the entity which runs the model).

Regarding UE-side model with functionality-based performance monitoring, since the AI/ML model is inferred at the UE side, UE reporting overhead for performance monitoring might be very high if the network is the entity that monitors the AI/ML model's performance. In the current New Radio (NR) Release 18 (Rel-18) study item (SI) agreements, AI/ML beam management functionality-based performance monitoring only allows the network to indicate activation/deactivation/fallback/switching of any AI/ML functionalities via 3GPP signaling (e.g., radio resource control (RRC), medium access control (MAC) control element (CE), downlink control information (DCI)). The UE can calculate the monitored performance metrics and report to the network. Alternatively, the UE can report the AI/ML model's outputs and ground-truth to let the network calculate the monitored performance metrics. However, both options tend to result in high UE reporting overhead. It is noteworthy that there are some AI/ML functionalities that are more suitable for UE to make activation/deactivation/fallback/switching decisions. With the UE making the activation/deactivation/fallback/switching decisions, the UE reporting overhead could be reduced. Therefore, there is a need for a solution of functionality monitoring for AI/ML-based beam management in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to functionality monitoring for AI/ML-based beam management in mobile communications. It is believed that implementation of one or more schemes proposed herein may avoid or otherwise alleviate issue(s) described herein.

In one aspect, a method may involve a UE detecting a need to change an AI/ML beam management functionality. The method may also involve the UE reporting a request to change the AI/ML beam management functionality to a network responsive to the detecting. The method may additionally involve the UE receiving an indication from the network responsive to the reporting. The method may further involve the UE applying a decision related to the AI/ML beam management functionality according to the indication.

In another aspect, an apparatus implementable in a UE may include a transceiver configured to communicate wirelessly and a processor coupled to the transceiver. The processor may detect a need to change an AI/ML beam management functionality. The processor may also report a request to change the AI/ML beam management functionality to a network responsive to the detecting. The processor may receive an indication from the network responsive to the reporting. The processor may apply a decision related to the AI/ML beam management functionality according to the indication.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IOT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a beam management procedure in accordance with implementations of the present disclosure.

FIG. 2 is a diagram depicting an example scenario under a proposed scheme in accordance with the present disclosure.

FIG. 3 is a diagram depicting an example communication system having an example communication apparatus and an example network apparatus in accordance with an implementation of the present disclosure.

FIG. 4 is a diagram depicting an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to functionality monitoring for AI/ML-based beam management in mobile communications. According to the present disclosure, a number of possible solutions may be implemented separately or jointly. That is, although these possible solutions may be described below separately, two or more of these possible solutions may be implemented in one combination or another.

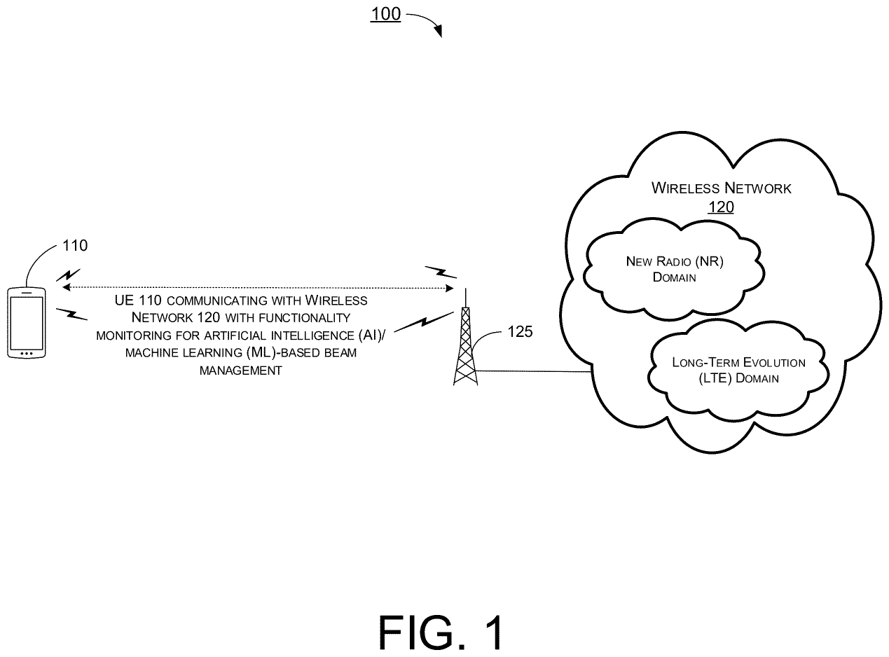

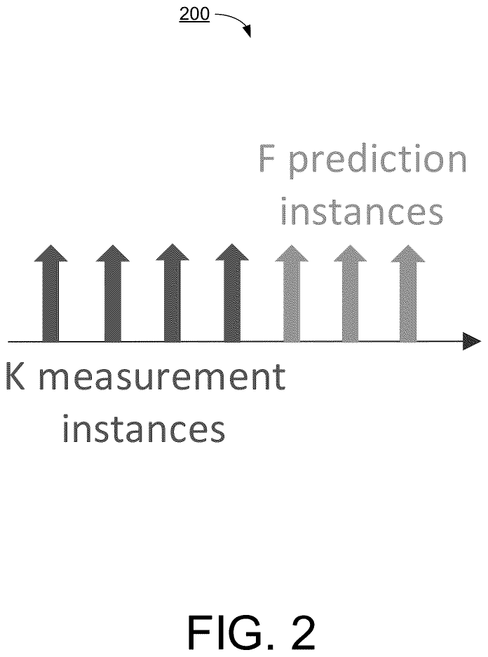

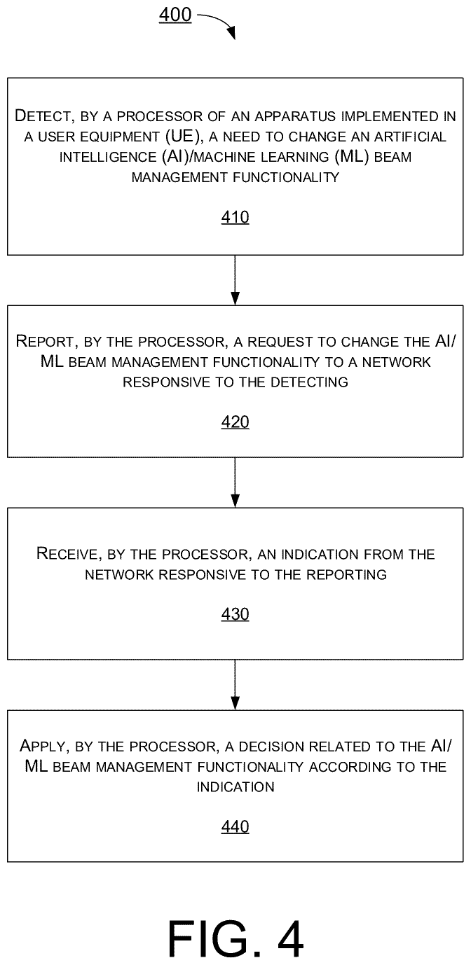

FIG. 1 illustrates an example network environment 100 in which various solutions and schemes in accordance with the present disclosure may be implemented. FIG. 2~FIG. 4 illustrate examples of implementation of various proposed schemes in network environment 100 in accordance with the present disclosure. The following description of various proposed schemes is provided with reference to FIG. 1~FIG. 4.

Referring to FIG. 1, network environment 100 may involve a UE 110, such as a mobile device or smartphone, in wireless communication with a wireless network 120 as part of a communication network. The wireless network 120 may be a public land mobile network (PLMN) including 5G/NR domain and LTE domain. UE 110 may be in, or attempting to establish, wireless communication with wireless network 120 via a base station or network node 125 (e.g., an eNB, gNB or transmit-receive point (TRP)). In network environment 100, UE 110 and wireless network 120 via network node 125 may implement various schemes pertaining to enhancement of functionality monitoring for AI/ML-based beam management in mobile communications, as described herein. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

FIG. 2 illustrates an example scenario 200 under a proposed scheme in accordance with the present disclosure. Scenario 200 may pertain to temporal beam prediction, which is related to various observation window lengths (F) and prediction window lengths (K), as two of the AI/ML beam management functionalities. In the present disclosure, the term “observation window length” denotes a number of time instances used for AI/ML model input, and it is represented by parameter F. Moreover, in the present disclosure, the term “prediction window length” denotes a number of time instances the AI/ML model makes a prediction, and it is represented by parameter K. During capability report, UE 110 may report to network 120 its temporal beam prediction, with K={1, 2, 4, 8} and F={1, 2, 4} as one of its UE capability AI/ML functionalities. When UE 110 detects any of a number of predefined events that require a change for this functionality, UE 110 may report the requested activation/deactivation/fallback/switching decisions (herein interchangeably referred to as “life cycle management decisions”). For instance, when UE 110 detects an increase in its speed from 30 km/h to 60 km/h, UE 110 may request to change from (K=8, F=4) to (K=2, F=1) to predict the best beam more frequently. Correspondingly, network 120 may assess the request and indicate to UE 110 whether the request is granted or not. UE 110 may apply the corresponding life cycle management decisions according to the indication received from network 120.

Under another proposed scheme in accordance with the present disclosure, the value of K for Top-K downlink (DL) transmission (Tx) beam prediction of either spatial or temporal beam prediction may be an AI/ML functionality in concern. When “Top-K DL Tx beam prediction” is one of the AI/ML beam management functionalities, during capability report, UE 110 may report to network 120 its “Top-K DL Tx beam prediction”, with K={1, 2, 4} as one of its UE AI/ML functionality capabilities. When UE 110 detects one of a number of predefined events that require a change for this functionality, UE 110 may report the requested activation/deactivation/fallback/switching decisions (or life cycle management decisions). For instance, when UE 110 detects that its model output has low probability values on each predicted Top-K beams as the best beams for transmission, UE 110 may request to change from K=1 to K =4 to report more beams to increase its beam prediction accuracy. Correspondingly, network 120 may assess the request and indicate to UE 110 whether the request is granted or not. UE 110 may apply the corresponding life cycle management decisions according to the indication received from network 120.

In view of the above, certain aspects of the proposed schemes with respect to a UE-side model may be summarized below.

In one aspect, when “temporal beam prediction-various observation window lengths (F) and prediction window lengths (K)” is one of the AI/ML beam management functionalities, UE 110 may, during capability reporting, report its “temporal beam prediction” functionality to network 120, with certain values of K and K as its capable AI/ML functionality. When this AI/ML functionality is activated with certain K and F values, and when UE 110 detects one of a number of predefined events that require a change for this functionality, UE 110 may report one or more requested activation/deactivation/fallback/switching decisions to network 120. The change may be a change of K and/or F value(s) and/or deactivation of the whole “temporal beam prediction” functionality. Network 120 may assess the request and indicate to UE 110 whether the request is granted or not. UE 110 may then apply the corresponding activation/deactivation/fallback/switching decisions for a current activated AI/ML functionality according to the indication received from network 120.

In another aspect, when “Top-K DL Tx beam prediction, with various values of K” is one of the AI/ML beam management functionalities, UE 110 may, during capability reporting, report its “Top-K DL Tx beam prediction” functionality to network 120, with certain values of K as its capable AI/ML functionality. When this AI/ML functionality is activated with a certain value of K, and when UE 110 detects one of a number of predefined events that require a change for this functionality, UE 110 may report one or more requested activation/deactivation/fallback/switching decisions to network 120. The change may be a change of K value and/or deactivation of the whole “Top-K DL Tx beam prediction” functionality. Network 120 may assess the request and indicate to UE 110 whether the request is granted or not. UE 110 may then apply the corresponding activation/deactivation/fallback/switching decisions for a current activated AI/ML functionality according to the indication received from network 120.

### Illustrative Implementations

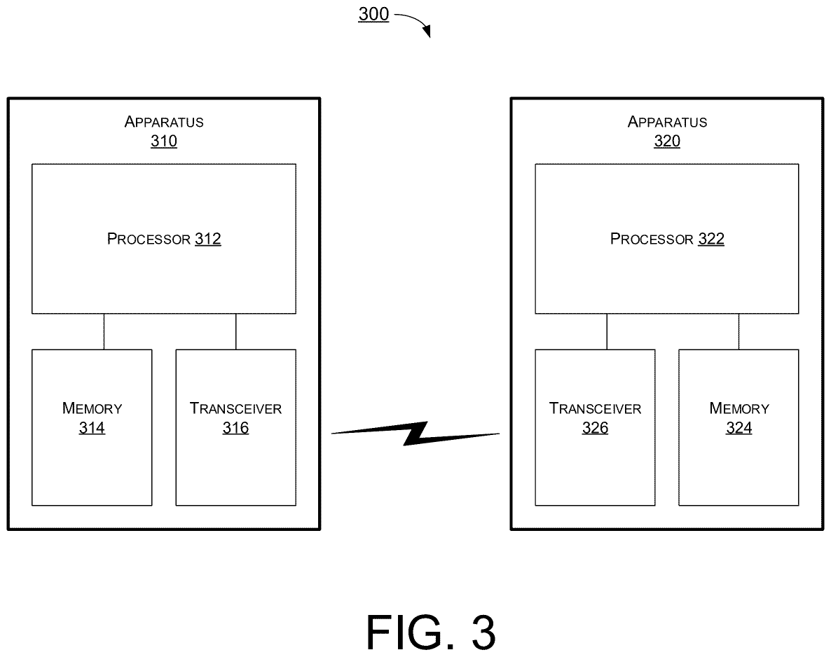

FIG. 3 illustrates an example communication system 300 having at least an example apparatus 310 and an example apparatus 320 in accordance with an implementation of the present disclosure. Each of apparatus 310 and apparatus 320 may perform various functions to implement schemes, techniques, processes and methods described herein pertaining to functionality monitoring for AI/ML-based beam management in mobile communications, including the various schemes described above with respect to various proposed designs, concepts, schemes, systems and methods described above, including network environment 100, as well as processes described below.

Each of apparatus 310 and apparatus 320 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 310 and apparatus 320 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 310 and apparatus 320 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 310 and apparatus 320 may be implemented in a smart thermostat, a smart fridge, a smart door lock, a wireless speaker or a home control center. When implemented in or as a network apparatus, apparatus 310 and/or apparatus 320 may be implemented in an eNodeB in an LTE, LTE-Advanced or LTE-Advanced Pro network or in a gNB or TRP in a 5G network, an NR network, or an IoT network.

In some implementations, each of apparatus 310 and apparatus 320 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 310 and apparatus 320 may be implemented in or as a network apparatus or a UE. Each of apparatus 310 and apparatus 320 may include at least some of those components shown in FIG. 3 such as a processor 312 and a processor 322, respectively, for example. Each of apparatus 310 and apparatus 320 may further include one or more other components not pertinent to the proposed scheme of the present disclosure (e.g., internal power supply, display device and/or user interface device), and, thus, such component(s) of apparatus 310 and apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC or RISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged, and configured to perform specific tasks including those pertaining to UE behavior for functionality monitoring for AI/ML-based beam management in mobile communications in accordance with various implementations of the present disclosure.

In some implementations, apparatus 310 may also include a transceiver 316 coupled to processor 312. Transceiver 316 may be capable of wirelessly transmitting and receiving data. In some implementations, transceiver 316 may be capable of wirelessly communicating with different types of wireless networks of different radio access technologies (RATs). In some implementations, transceiver 316 may be equipped with a plurality of antenna ports (not shown) such as, for example, four antenna ports. That is, transceiver 316 may be equipped with multiple transmit antennas and multiple receive antennas for multiple-input multiple-output (MIMO) wireless communications. In some implementations, apparatus 320 may also include a transceiver 326 coupled to processor 322. Transceiver 326 may include a transceiver capable of wirelessly transmitting and receiving data. In some implementations, transceiver 326 may be capable of wirelessly communicating with different types of UEs/wireless networks of different RATs. In some implementations, transceiver 326 may be equipped with a plurality of antenna ports (not shown) such as, for example, four antenna ports. That is, transceiver 326 may be equipped with multiple transmit antennas and multiple receive antennas for MIMO wireless communications.

In some implementations, apparatus 310 may further include a memory 314 coupled to processor 312 and capable of being accessed by processor 312 and storing data therein. In some implementations, apparatus 320 may further include a memory 324 coupled to processor 322 and capable of being accessed by processor 322 and storing data therein. Each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory.

Each of apparatus 310 and apparatus 320 may be a communication entity capable of communicating with each other using various proposed schemes in accordance with the present disclosure. For illustrative purposes and without limitation, a description of capabilities of apparatus 310, as a UE (e.g., UE 110), and apparatus 320, as a network node (e.g., network node 125) of a network (e.g., wireless network 120 as a 5G/NR mobile network), is provided below in the context of example process 400.

### Illustrative Processes

FIG. 4 illustrates an example process 400 in accordance with an implementation of the present disclosure. Process 400 may represent an aspect of implementing various proposed designs, concepts, schemes, systems and methods described above. More specifically, process 400 may represent an aspect of the proposed concepts and schemes pertaining to functionality monitoring for AI/ML-based beam management in mobile communications in accordance with the present disclosure. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively, in a different order. Furthermore, one or more of the blocks/sub-blocks of process 400 may be executed repeatedly or iteratively. Process 400 may be implemented by or in apparatus 310 and apparatus 320 as well as any variations thereof. Solely for illustrative purposes and without limiting the scope, process 400 is described below in the context of apparatus 310 as a UE (e.g., UE 110) and apparatus 320 as a communication entity such as a network node or base station (e.g., network node 125) of a network (e.g., wireless network 120). Process 400 may begin at block 410.

At 410, process 400 may involve processor 312 of apparatus 310 detecting a need to change an AI/ML beam management functionality. Process 400 may proceed from 410 to 420.

At 420, process 400 may involve processor 312 reporting, via transceiver 316, a request to change the AI/ML beam management functionality to a network (e.g., wireless network 120 via apparatus 320 as network node 125) responsive to the detecting. Process 400 may proceed from 420 to 430.

At 430, process 400 may involve processor 312 receiving, via transceiver 316, an indication from the network responsive to the reporting. Process 400 may proceed from 430 to 440.

At 440, process 400 may involve processor 312 applying a decision related to the AI/ML beam management functionality according to the indication.

In some implementations, the AI/ML beam management functionality may include a temporal beam prediction functionality. In some implementations, the temporal beam prediction functionality may be related to an observation window length (F) and a prediction window length (K). In some implementations, in reporting the request to change the AI/ML beam management functionality, process 400 may involve processor 312 requesting to change values of the F and K or requesting to deactivate the temporal beam prediction functionality.

In some implementations, the AI/ML beam management functionality may include a top-K DL Tx beam prediction functionality of a spatial or temporal beam prediction. In some implementations, the top-K DL Tx beam prediction functionality may be related to a top K number of beams predicted as best beams. In some implementations, in reporting the request to change the AI/ML beam management functionality, process 400 may involve processor 312 requesting to change a value of K or requesting to deactivate the top-K DL Tx beam prediction functionality.

In some implementations, in detecting the need to change the AI/ML beam management functionality, process 400 may involve processor 312 detecting a change in a speed of the UE or detecting a low probability value of an output of an AI/ML model on each predicted top K number of beams.

In some implementations, in reporting the request to change the AI/ML beam management functionality, process 400 may involve processor 312 reporting a requested change in life cycle management (e.g., activation, deactivation, fallback or switching).

In some implementations, process 400 may further involve processor 312 reporting, via transceiver 316, the AI/ML beam management functionality to the network during capability reporting.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
detecting, by a processor of an apparatus implemented in a user equipment (UE), a need to change an artificial intelligence (AI)/machine learning (ML) beam management functionality;
reporting, by the processor, a request to change the AI/ML beam management functionality to a network responsive to the detecting;
receiving, by the processor, an indication from the network responsive to the reporting; and
applying, by the processor, a decision related to the AI/ML beam management functionality according to the indication.

2. The method of claim 1, wherein the AI/ML beam management functionality comprises a temporal beam prediction functionality.

3. The method of claim 2, wherein the temporal beam prediction functionality is related to an observation window length (F) and a prediction window length (K).

4. The method of claim 3, wherein the reporting of the request to change the AI/ML beam management functionality comprises requesting to change values of the F and K or requesting to deactivate the temporal beam prediction functionality.

5. The method of claim 1, wherein the AI/ML beam management functionality comprises a top-K downlink (DL) transmission (Tx) beam prediction functionality of a spatial or temporal beam prediction.

6. The method of claim 5, wherein the top-K DL Tx beam prediction functionality is related to a top K number of beams predicted as best beams.

7. The method of claim 6, wherein the reporting of the request to change the AI/ML beam management functionality comprises requesting to change a value of K or requesting to deactivate the top-K DL Tx beam prediction functionality.

8. The method of claim 1, wherein the detecting of the need to change the AI/ML beam management functionality comprises detecting a change in a speed of the UE or detecting a low probability value of an output of an AI/ML model on each predicted top K number of beams.

9. The method of claim 1, wherein the reporting of the request to change the AI/ML beam management functionality comprises reporting a requested change in life cycle management.

10. The method of claim 1, further comprising:
reporting, by the processor, the AI/ML beam management functionality to the network during capability reporting.

11. An apparatus implementable in a user equipment (UE), comprising:
a transceiver configured to communicate wirelessly; and
a processor coupled to the transceiver and configured to perform operations comprising:
detecting a need to change an artificial intelligence (AI)/machine learning (ML) beam management functionality;
reporting, via the transceiver, a request to change the AI/ML beam management functionality to a network responsive to the detecting;
receiving, via the transceiver, an indication from the network responsive to the reporting; and
applying a decision related to the AI/ML beam management functionality according to the indication.

12. The apparatus of claim 11, wherein the AI/ML beam management functionality comprises a temporal beam prediction functionality.

13. The apparatus of claim 12, wherein the temporal beam prediction functionality is related to an observation window length (F) and a prediction window length (K).

14. The apparatus of claim 13, wherein the reporting of the request to change the AI/ML beam management functionality comprises requesting to change values of the F and K or requesting to deactivate the temporal beam prediction functionality.

15. The apparatus of claim 11, wherein the AI/ML beam management functionality comprises a top-K downlink (DL) transmission (Tx) beam prediction functionality of a spatial or temporal beam prediction.

16. The apparatus of claim 15, wherein the top-K DL Tx beam prediction functionality is related to a top K number of beams predicted as best beams.

17. The apparatus of claim 16, wherein the reporting of the request to change the AI/ML beam management functionality comprises requesting to change a value of K or requesting to deactivate the top-K DL Tx beam prediction functionality.

18. The apparatus of claim 11, wherein the detecting of the need to change the AI/ML beam management functionality comprises detecting a change in a speed of the UE or detecting a low probability value of an output of an AI/ML model on each predicted top K number of beams.

19. The apparatus of claim 11, wherein the reporting of the request to change the AI/ML beam management functionality comprises reporting a requested change in life cycle management.

20. The apparatus of claim 11, wherein the processor is further configured to perform operations comprising:
reporting, via the transceiver, the AI/ML beam management functionality to the network during capability reporting.
